(19) United States
(12) Patent Application Publication
(10) Pub. No.: US 2025/0217168 A1
(43) Pub. Date: Jul. 3, 2025

(54) USER INTERFACE FOR OBJECT UPDATES

(71) Applicant: Atlassian Pty Ltd., Sydney (AU)

(72) Inventors: Rachel Lin, Sydney (AU); Nathan Flew, Sydney (AU); Bradley John Rodgers, Sydney (AU); Sherif George Mansour, Sydney (AU); Kristy Donaldson, Sydney (AU); Niraj Arun Patil, Melbourne (AU)

(21) Appl. No.: 18/399,652

(22) Filed: Dec. 28, 2023

(51) Int. Cl. G06F 9/451; G06F 3/0482; G06F 3/04855

(52) U.S. Cl. CPC G06F 9/451; G06F 3/0482; G06F 3/04855

(57) ABSTRACT

Described herein is a computer implemented method that includes maintaining a plurality of subscriber updates in a data store, each subscriber update including a plurality of object updates for objects subscribed to by subscribers, each object update includes a latest object information associated with the object. The method further includes displaying a standard user interface that includes displaying the plurality of object updates subscribed to by a first subscriber, the object updates arranged in a sequential list; detecting activation of a reading mode control displayed on the standard user interface; in response, replacing the standard user interface with a reading mode user interface that includes displaying a first object update; and while displaying the reading mode user interface, detecting a navigation input and in response to the navigation input, ceasing display of the first object update and displaying a second object update.

### TECHNICAL FIELD

Aspects of the present disclosure are directed to human-machine interfaces and, more particularly, to improved user interfaces for displaying object updates.

### BACKGROUND

Computer applications may provide functionality for users to collaborate in respect of projects and may provide status updates to users who are subscribed to projects. Organizations may have several projects ongoing simultaneously and users may be subscribed to multiple of these projects. Where users are subscribed to many projects, it may be challenging for users to view project updates and navigate between updates in respect of different projects without increasing cognitive burden.

### SUMMARY

Example methods described herein may include maintaining a plurality of subscriber updates in a data store. Each subscriber update may include a plurality of respective object updates in respect of objects subscribed to by subscribers. Further, each object update may include a latest object information associated with the object. The method may further include displaying a standard user interface. The standard user interface may include display of the plurality of respective object updates in respect of the objects subscribed by a first subscriber. The object updates are arranged in a sequential list and the standard user interface may include a scrolling mechanism to scroll through the sequential list. In addition, the method may include detecting activation of a reading mode control displayed on the standard user interface, and in response to detecting activation of the reading mode control, replacing the standard user interface with a reading mode user interface. The reading mode user interface may include display of a first object update of the plurality of respective object updates at a time. The method may further include while displaying the reading mode user interface, detecting a navigation input and in response to the navigation input, ceasing display of the first object update and displaying a second object update of the plurality of respective object updates in the reading mode user interface.

Some example embodiments are directed to a system which may include a processor, a display, an input device, and a non-transitory computer readable medium comprising instructions, which when executed by the processor, cause the system to perform the steps of the methods described above.

Some example embodiments are directed to non-transitory computer readable medium which when executed by a processor causes the processor to perform the methods described above.

### BRIEF DESCRIPTION OF THE DRAWINGS

In the drawings:

FIG. 1 is a user interface of a project communication tool.

FIG. 2 is a block diagram of a networked environment in which various features of the present disclosure may be implemented.

FIG. 3 is a block diagram of a computing system with which various embodiments of the present disclosure may be implemented.

FIG. 4 is a flowchart depicting an example method for creating and displaying subscriber updates according to embodiments of the present disclosure.

FIG. 5 is an example first subscriber update user interface (standard interface) according to embodiments of the present disclosure.

FIG. 6 is an example second subscriber update user interface (reading mode user interface) according to embodiments of the present disclosure.

FIG. 7 is an example alternative interface element applicable to the interface of FIG. 6.

FIG. 8 is an example alternative interface element applicable to the interface of FIG. 6.

FIG. 9 is a flowchart depicting an example method for displaying subscriber updates in a reading mode according to embodiments of the present disclosure.

While the description is amenable to various modifications and alternative forms, specific embodiments are shown by way of example in the drawings and are described in detail. It should be understood, however, that the drawings and detailed description are not intended to limit the disclosure to the particular form disclosed. The intention is to cover all modifications, equivalents, and alternatives falling within the scope of the present disclosure as defined by the appended claims.

### DETAILED DESCRIPTION

In the following description numerous specific details are set forth in order to provide a thorough understanding of the present disclosure. It will be apparent, however, that the present disclosure may be practiced without these specific details. In some instances, well-known structures and devices are shown in block diagram form in order to avoid unnecessary obscuring.

The methods, user interfaces, and systems described herein can be employed with any other computer application that requires displaying a plurality of UI objects or UI cards in a single user interface. For example, the methods, UIs, and systems described herein can be utilized for displaying social media posts, news items, project task, project updates, etc., without departing from the scope of the present application.

An object or UI card according to the present disclosure is a UI element associated with a particular topic that includes information about the topic. For example, in the case of a social media application, a UI card may be a post or tweet that includes the actual post or tweet text, information about the author of the post, and other information such as date posted, number of interactions with the post, etc. In the case of a project management application, a UI card may be a task card that includes details about the task including, e.g., task creation date, task completion date, assignee, status, etc. Similarly, in the case of a project communication tool, a UI card may be a project update object that includes information about the project update including, e.g., project name, project owner, status, update description, etc.

Aspects of the present disclosure are described with respect to a particular example computer application—a project communication tool that provides status updates of projects and user interfaces therefor. For ease of reference, the acronyms PCT or PC will at times be used herein in place of “project communication tool” or “project communication”, respectively. It will be appreciated that this tool is merely used as an example and as described above, aspects of the present disclosure can be used with any other computer applications without departing from the scope of the present disclosure.

As discussed above, organizations may have several projects ongoing simultaneously and may implement computer applications, for example a PCT application, for users to collaborate in respect of the projects. Generally speaking, the PCT provides status updates of projects. Specifically, the project communication tool allows users to conveniently create and subscribe to (e.g., follow) projects. The tool is also configured to automatically prompt project owners for periodic project updates and deliver digests of project updates (subscriber updates) to subscribers. The PCT may also be used to create and update goals which may relate to one or more projects.

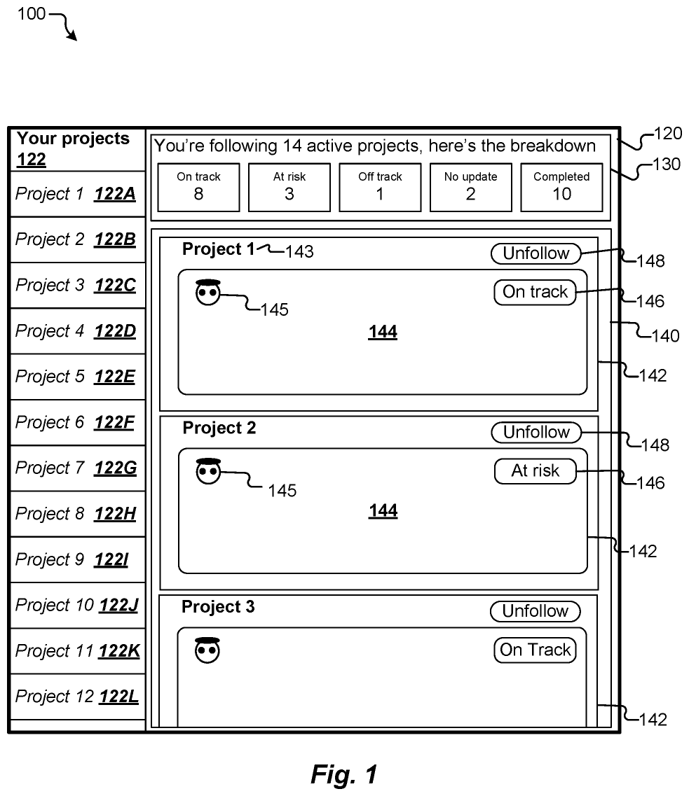

Project and/or goal updates (and digests thereof) may be provided to subscribers by displaying UI cards or objects for the updates in a user interface of the PCT and allowing the subscriber to view the updates. FIG. 1 illustrates an example user interface 100 that may be displayed by a PCT application to display project updates. The user interface 100 may be displayed when the subscriber initially wishes to view their subscribed updates. The interface 100 displays a list of projects 122A-122L subscribed to (i.e. followed) and/or owned by a user viewing the interface 100. In this example, the user follows and/or owns fourteen projects, although only projects 1-12 are displayed within the section 122 of interface 100—projects 122A-122L. Projects 13 and 14 (and any additional projects) would require scrolling, searching, or further navigating within the interface to view. Selection of the goals control element 514 may cause display of a similar display of a goals section for displaying a list of goals subscribed to (i.e. followed) and/or owned by the user viewing the interface.

The interface 100 further includes a summary section 130 displaying a summary of the active projects the user viewing the interface 100 has subscribed to follow. In this example, 14 of the projects the user has subscribed to follow are active and therefore the summary section 130 includes a status summary (e.g. on track, at risk, off track) for each of these 14 active projects along with an indication of the completed (and therefore, no longer active) projects.

The interface further includes a project updates section 140. The project updates section 140 displays project update objects 142 or cards for each project the user has subscribed to that has recently been updated. The project updates section 140 is a scrollable interface for allowing a subscriber to view each project update object 142 by scrolling through the list of project update objects 142.

Each project update object 142 includes information about the corresponding project, e.g. information of the corresponding project update record. This may include, e.g., a project name 143, a project update description 144, an avatar 145, a status indicator 146, and an unfollow control 148.

Each project update object 142 may also include additional sections to display additional data in relation to the respective project. For example, project update objects 142 may further include sections for subscriber remarks (e.g. comments and/or reactions) and/or sections to display a change in status and/or target date for the respective project (not shown). Expansion of project update objects with additional sections affects the number of project update objects 142 displayable at any time within the project updates section 140. The project updates section 140 is thus configured as an infinite scroll interface, allowing a user to scroll through (and down to) respective project update objects 142.

As can be seen in FIG. 1, interface 100 provides a display of a wide variety of information and access to many control elements. However, where a user is subscribed to many projects and/or receives many project updates in their subscriber update for a given period, user interface 100 may be too cluttered and may increase the cognitive burden on the user. Further, it may be challenging for a user to navigate interface 100 and effectively view and digest all project update information relevant to the projects they follow without distractions.

Accordingly, it may be desirable to have improved user interfaces for computer applications which enable more efficient and effective display and navigation of updates.

In the following, an overview of an example environment illustrating different systems involved in certain embodiments will be described, followed by a description of a computer system which can be configured in various ways to perform the embodiments/various features thereof as described herein. Following this, exemplary user interfaces of a project communication software tool will be described.

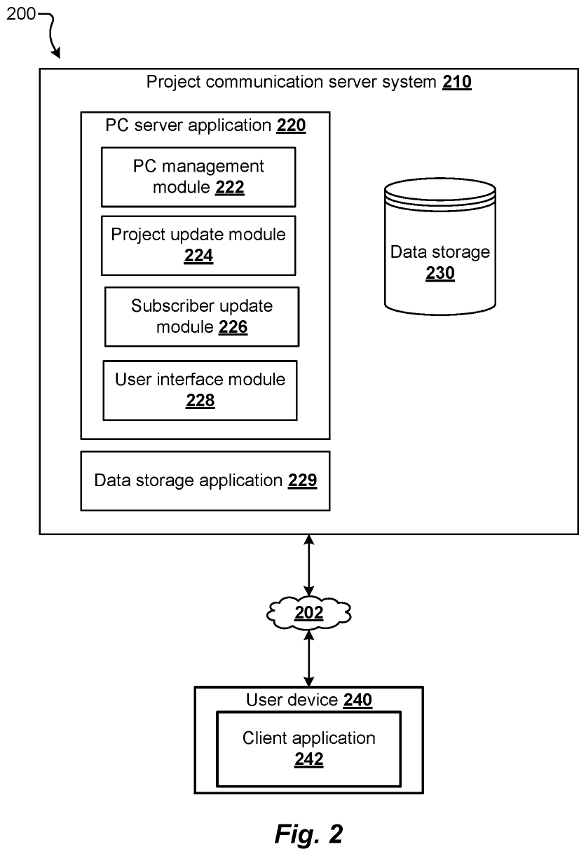

FIG. 2 illustrates an example environment 200 in which embodiments and features of the present disclosure are implemented. Example environment 200 includes a communications network 202 which interconnects a project communication server system 210, and a user device 240.

The project communication server system 210 includes a PC server application 220 (server application 220 for short) and a PC server system data store 230 (data store 230 for short). The data store 230 is used for storing data related to functions performed by the server application 220, for example, project data of one or more projects managed by the PC server application 220.

The server application 220 and its respective modules configure the PC server system 210 to provide server side functionality for client applications (e.g., client application 242). Generally speaking, this involves receiving and responding to requests from client applications (e.g. client application 242 discussed below). The server application 220 may be a web server (for interacting with web browser clients) or an application server (for interacting with dedicated application clients). While PC server system 210 has been illustrated with a single server application 220, it may provide multiple server applications (e.g. one or more web servers and/or one or more application servers).

In this example, the server application 220 includes a PC management module 222, a project update module 224, a subscriber update module 226, and a user interface module 228.

Generally speaking, the PC management module 222 is configured to collect project data when a project is created and store the collected project data in the data store 230. The PC management module 222 is also configured to collect subscriber data (e.g., user identifiers who have subscribed to a project) and store the subscriber data in the data store 230. As an example, the PC management module 222 may be configured to write the project data to a project details record in a project details table stored on the data store 230 and write the subscriber data to a respective subscriber record of a subscriber table stored on the data store 230. For ease of reference, the PC management module 222 may, at times, be referred to herein as a PCM module.

The project update module 224 is configured to periodically prompt a project owner (e.g. through the client application 242 on user device 240) to provide a project update relating to their project. The project update module 224 is also configured to receive project updates from a project owner (e.g. using the client application 242 on user device 240) and store the project updates in the data store 230. As an example, the project update module 224 may be configured to write each received project update to a project update record in a project updates table stored on the data store 230.

The subscriber update module 226 is configured to periodically provide project updates to subscribers. For a given subscriber (i.e. user), the subscriber update module 226 is configured to periodically retrieve project updates (e.g. from the data store 230) relating to the projects the subscriber has subscribed to and generate a subscriber update based on the retrieved project updates. After the subscriber update module 226 has generated the subscriber update, the subscriber update module 226 is configured to communicate the subscriber update to the subscriber. The subscriber update module 226 may communicate the subscriber update to the subscriber through client application 242 on user device 240, by email to the subscriber's nominated email address(es), and/or other communication means. As an example, the subscriber's user identifier stored in a subscriber table may be used to identify the subscriber's details in a user table to determine the subscriber's nominated email address(es).

The user interface module 228 is configured to generate and display user interfaces to client applications, for example, on client application 242 of user device 240. The user interfaces are configured to enable a user to input project updates relating to projects they are the owner of and/or to display project updates relating to projects they are subscribed to. The user interface module 228 and the interfaces it provides are also configured to enable various control elements, for example buttons and/or affordances which may be activated selecting the element with a touch gesture and/or by clicking with a cursor. User interface control elements may also include inputs received from input devices, such as physical buttons of a user device and/or a keyboard. As will be outlined below, the user interface module 228 may provide various control elements and functionalities responsive to detecting user input and/or activation of the control elements.

The data storage application 229 is configured to receive and process requests to persistently store and retrieve, to and from data store 230, data relevant to the operations performed/services provided by the server application 220. Such requests may be received from the server application 220, other server environment applications, and/or (in some instances) directly from client applications such as 242. The data storage application 229 may, for example, be a relational database management application or an alternative application for storing and retrieving data from data store 230. Data relevant to the operations performed/services provided by the server system 210 may include, for example, user account data, project data, project update data, goal data, subscriber data, and other data as described herein.

In the present example, the project communication management module 222, the project update module 224, the subscriber update module 226, and the user interface module 228 have been described as modules of the server application 220—for example add-ons, plug-ins, or other software components that integrate with and expand the functionality of the server application 220. The functionality provided by one or more of these modules could, however, be performed by separate/stand-alone applications. As a further alternative, the functionality provided by one or more of these modules could be native functionality of the server application 220.

In certain embodiments, the PC server system 210 is a scalable system. Depending on demand from clients (and/or other performance requirements), compute nodes can be provisioned/de-provisioned on demand. As an example, if there is high client demand additional server applications 220 may be provisioned to cater for that demand. In this case, each functional component of the PC server system 210 may involve one or several applications running on the same or separate computer systems, each application including one or more application programs, libraries, APIs or other software that implements the functionality described herein.

The server application 220 executes to provide a client application endpoint that is accessible over communications network 202. To do so, the server application 220 may include one or more application programs, libraries, APIs or other software elements that implement the features and functions that are described herein. For example, where server application 220 serves web browser client applications the server application 220 will be a web server which receives and responds to, for example, HTTP application protocol requests. Where server application 220 serves native client applications, server application 220 will be an application server configured to receive, process, and respond to API calls from those client applications

The server system 210 may include both web server and application server applications allowing it to interact with both web and native client applications.

Server application 220 (and/or other applications running in the server system 210) can be implemented as a monolithic application. Alternatively, server application 220 can be implemented as a collection of independent and autonomous application services (e.g. microservices). In this case, the constituent application services of server application 220 communicate amongst themselves, with other front end server applications 220, and/or with client application 242, via defined interfaces such as web APIs.

In addition to the specific functionality described herein, the server application 220 (alone or in conjunction with other applications) may provide additional functions that are typically provided by server systems—for example user account creation and management, user authentication, and/or other server side functions.

Data store 230 may be any appropriate data storage device (or set of devices), for example one or more non transient computer readable storage devices such as hard disks, solid state drives, tape drives, or alternative computer readable storage devices. Furthermore, while a single instance of data store 230 is described, server system 210 may include multiple instances of data storage.

The user device 240 includes a client application 242, which, when executed by the user device 240 (e.g. by a processing unit such as 302 described below), configures the user device 240 to provide project communication functionality to allow users to do one or more of: create projects, update projects, subscribe to projects, and/or receive project updates. This involves communicating with the PC server system 210 (and, in particular, the server application 220).

The client application 242 may be the same for project subscribers and project owners. However, it is envisaged that the user device 240 and client application 242 may be different and operate differently for project owners and subscribers. For example, the client application 242 for project owners may be different to (and/or may have more functionality when compared to) the client application for subscribers. In some cases, subscribers may not even need a client application 242 if subscriber updates are, for example, delivered by email or other communication means. Further, it will be appreciated that in some cases, a project owner for one project may be a project subscriber for another project and vice versa.

The client application 242 may be implemented in various ways. For example, the client application 242 may be web browser applications (such as Chrome, Safari, Internet Explorer, Firefox, or an alternative web browser), which access the applications hosted by the PC server system 210 via appropriate uniform resource locators (URL) and communicate with the PC server system 210 via general world-wide-web protocols. In this case, the web browser application is configured to request, render and display UIs that conform to a markup language, and may be capable of internally executing browser-executable code, or other forms of code. Alternatively, the client applications 242 may be specific applications programmed to communicate with the PC server system 210 using defined application programming interface (API) calls.

In the present example, while a single user device 240 and a single client application 242 has been depicted, environment 200 will typically include multiple user devices 240 and multiple client applications 242, each configured to interact with the PC server system 210. User device 240 may be any form of computing device. Typically, user device 240 is a personal computing device—e.g. a desktop computer, laptop computer, tablet computer, smart phone, or other computing device.

Communications between the various systems in environment 200 are via the communications network 202. Communications network 202 may be a local area network, public network (e.g. the Internet), or a combination of both.

While environment 200 has been provided as an example, alternative system environments/architectures are possible.

The features and techniques described herein are implemented using one or more computer processing systems. For example, in networked environment 200 described above, user device 240 may be computer processing systems (for example, a personal computer, tablet/phone device, or other appropriate computer processing system) which is configured (or configurable) by hardware and/or software to offer client-side functionality. Similarly, the various functions performed by the PC server system 210 are performed by one or more computer processing systems (e.g. server computers or other computer processing systems).

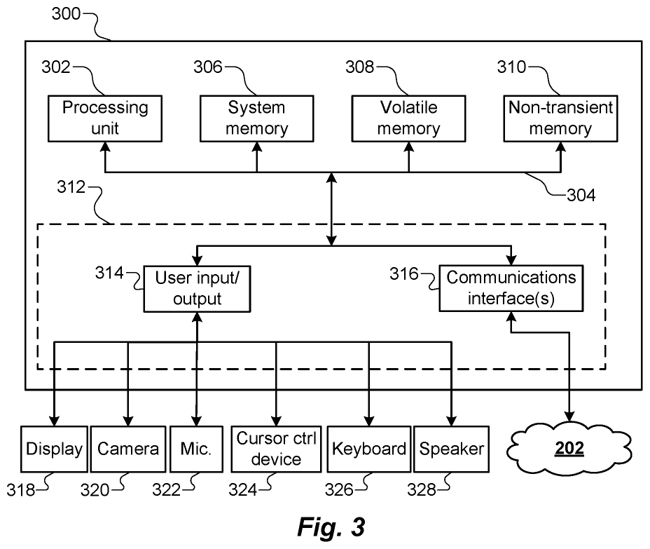

FIG. 3 is a block diagram of a computer processing system 300 configurable to perform various functions described herein. For example, systems 210 and/or 240 of FIG. 2 may be (or include) a computer processing system such as that shown in FIG. 3 (although alternative architectures are possible).

System 300 is a general purpose computer processing system. It will be appreciated that FIG. 3 does not illustrate all functional or physical components of a computer processing system. For example, no power supply or power supply interface has been depicted, however system 300 will either carry a power supply or be configured for connection to a power supply (or both). It will also be appreciated that the particular type of computer processing system will determine the appropriate hardware and architecture, and alternative computer processing systems suitable for implementing features of the present disclosure may have additional, alternative, or fewer components than those depicted.

Computer processing system 300 includes at least one processing unit 302. The processing unit 302 may be a single computer processing device (e.g. a central processing unit, graphics processing unit, or other computational device), or may include a plurality of computer processing devices. In some instances, where a computer processing system 300 is described as performing an operation or function all processing required to perform that operation or function will be performed by processing unit 302. In other instances, processing required to perform that operation or function may also be performed by remote processing devices accessible to and usable by (either in a shared or dedicated manner) system 300.

Through a communications bus 304, the processing unit 302 is in data communication with a one or more machine readable storage (memory) devices which store instructions and/or data for controlling operation of the processing system 300. In this example system 300 includes a system memory 306 (e.g. a BIOS), volatile memory 308 (e.g. random access memory such as one or more DRAM modules), and non-volatile memory 310 (e.g. one or more hard disk or solid state drives).

System 300 also includes one or more interfaces, indicated generally by 312, via which system 300 interfaces with various devices and/or networks. Generally speaking, other devices may be integral with system 300, or may be separate. Where a device is separate from system 300, connection between the device and system 300 may be via wired or wireless hardware and communication protocols, and may be a direct or an indirect (e.g. networked) connection.

Wired connection with other devices/networks may be by any appropriate standard or proprietary hardware and connectivity protocols. For example, system 300 may be configured for wired connection with other devices/communications networks by one or more of: Universal Serial Bus (USB); eSATA; Thunderbolt; Ethernet; HDMI. Other wired connections are possible.

Wireless connection with other devices/networks may similarly be by any appropriate standard or proprietary hardware and communications protocols. For example, system 300 may be configured for wireless connection with other devices/communications networks using one or more of: infrared; BlueTooth; WiFi; near field communications (NFC); Global System for Mobile Communications (GSM), Enhanced Data GSM Environment (EDGE), long term evolution (LTE), wideband code division multiple access (W-CDMA), code division multiple access (CDMA). Other wireless connections are possible.

Depending on the particular system in question, devices to which system 300 connects include one or more input/output devices 314 to allow data to be input into/received by system 300 and one or more input/output devices 314 to allow data to be output by system 300. Example devices are described below, however it will be appreciated that not all computer processing systems will include all mentioned devices, and that additional and alternative devices to those mentioned may well be used.

For example, system 300 may include or connect to one or more input devices 314 by which information/data is input into (received by) system 300. Such input devices may, for example, include a keyboard, a pointing device (such as a mouse or trackpad), a touch screen, and/or other input devices. System 300 may also include or connect to one or more output devices 314 controlled by system 300 to output information. Such output devices may, for example, include one or more display devices (e.g. a LCD, LED, touch screen, or other display devices) and/or other output devices. System 300 may also include or connect to devices which act as both input and output devices, for example touch screen displays (which can receive touch signals/input and display/output data) and memory devices (from which data can be read and to which data can be written).

By way of example, where system 300 is an end user device (such as user device 240), it may include one or more of: a display 318 (which may be a touch screen display), a camera device 320, a microphone device 322 (which may be integrated with the camera device), a cursor control device 324 (e.g. a mouse, trackpad, or other cursor control device), a keyboard 326, one or more other input/output devices, and a speaker device 328.

System 300 also includes one or more communications interfaces 316 for communication with a network, such as network 202 of FIG. 2 (and/or a local network within the server system 210). Via the communications interface(s) 316, system 300 can communicate data to and receive data from networked systems and/or devices.

System 300 may be any suitable computer processing system, for example, a server computer system, a desktop computer, a laptop computer, a netbook computer, a tablet computing device, a mobile/smart phone, a personal digital assistant, or an alternative computer processing system.

System 300 stores or has access to computer applications (which may also be referred to as computer software or computer programs). Such applications include computer readable instructions and data which, when executed by processing unit 302, configure system 300 to receive, process, and output data. Instructions and data can be stored on non-transient machine readable medium such as 310 accessible to system 300. Instructions and data may be transmitted to/received by system 300 via a data signal in a transmission channel enabled (for example) by a wired or wireless network connection over an interface such as communications interface 316.

Typically, one application accessible to system 300 will be an operating system application. In addition, system 300 will store or have access to applications which, when executed by the processing unit 302, configure system 300 to perform various computer-implemented processing operations described herein. For example, and referring to the networked environment of FIG. 2 above, server system 210 includes one or more systems 300, which run a server application 220 to perform various operations described herein. Similarly, user device 240 runs a client application 242. In some cases part or all of a given computer-implemented method will be performed by system 210 itself, while in other cases processing may be performed by other devices (e.g. user device 240) in data communication with system 210.

Application 242 is configured to display an input user interface (UI), e.g. on display 318. Server application 220 (e.g. using the user interface module 228) may communicate with client application 242 to display the input UI. The input UI provides a mechanism for a user to engage with a project communication tool to create and subscribe to projects, to update projects, and to receive digests of project updates. In the present disclosure, the input UI provides a mechanism for users to interface with the PCT. Various input UIs are possible. One example is graphical user interface (GUI) and particular examples of GUIs will be outlined in the following description, although alternative UIs are also possible.

Data in respect of users, updates, and projects may be stored in various formats in the data store 230. This section describes data structures which may be employed in the present disclosure to generate and store projects, project updates, and subscriber updates. The data structures and fields described are provided by way of example only. Depending on the implementation, alternative design formats, which make use of the same, additional, fewer, and/or alternative fields may be used, and the processing described herein can be adapted for alternative formats. Further, the fields described in respect of a given data structure may be stored in one or more alternative data structures (e.g. across multiple linked data structures).

Generally speaking, a project is a set of collected project data relating to a project as defined by project fields. By way of example, project fields may include fields such as a unique project identifier field for storing an identifier used to uniquely identify a project, a project owner field for storing a user identifier of an individual (or a team) who is assigned the role of project owner, a project name field for storing a name for the project, a project status field for storing a value indicating a current status of the project. For example, a project status may be selected from a set of system or user defined status values. Example status values may include, but are not limited to, statuses such as “Pending”, “On track”, “At risk”, “Off track”, “Paused”, “Cancelled”, “Completed”, or the like. It will be appreciated that other status values may be used. It is also envisaged that a project creator and/or owner may be able to add custom status values.

In addition, the project fields may include a project target date field for storing a value indicating a target date of completion of the project. The project target data may indicate a specific date (e.g. a specific day), a period of time (e.g. a specific month or a specific quarter), or that selection of a completion date or period has been deferred.

It will be appreciated that the above list is not exhaustive and that a project may include additional and/or alternative project fields. Further, while some project fields may be made mandatory/required not all will be.

Project data—i.e. data defining project fields such as those above—may be stored in any appropriate data structure (or set of related data structures). By way of example, the project data may be stored in a set of related database tables as set out below.

In this example, a project details table stores project details records defining various data in respect of a project. For example, each project details record may store the following data:

| | | | | |
|---|---|---|---|---|
| Project | Project owner user | Project | Project | Project |
| ID | ID | name | status | target date |

The data store 230 may further store a project subscriber table associating subscribers (i.e. individuals and/or teams) with projects. In this example, each subscriber table record defines a subscriber identifier (e.g. a user identifier) and a project identifier. For example:

| | |
|---|---|
| Project ID | Subscriber ID |

The data store 230 may further store a project update table storing project updates submitted by the project owners. The project update table defines project update records, each of which includes: a project update identifier; a project identifier; an update timestamp recording the time and/or date the project update was submitted; an update description providing details of the project update; a project status defining the project status of the project at the time of the update; a project target date indicating the target date of completion at the time of the update; and a remarks field for any comments and/or reactions submitted by subscribers relating to the project update. Below is an example of a project update table.

| | | | | | | |
|---|---|---|---|---|---|---|
| Project | Project | Project | Update | Project | Project | Subscriber |
| update | ID | update | descrip- | status | target | remarks |
| ID | | timestamp | tion | | date | |

Project updates may be uniquely identified based on their project update identifier. Alternatively, project updates may be identified based on a combination of the respective project identifier and project update timestamp.

The data store 230 may further store subscriber updates as a collection of project updates in a subscriber update table. The subscriber update table defines subscriber update records, each of which includes: an associated subscriber identifier; a subscriber update identifier; a subscriber update period recording the period of time the subscriber update was generated for, project identifiers for projects the subscriber is subscribed to; and project update identifiers for project updates of projects the subscriber is subscribed to. Below is an example of a project update table.

| | | | | |
|---|---|---|---|---|
| Subscriber | Subscriber | Subscriber | Project | Project |
| ID | update ID | update period | IDs | update IDs |

Additional and/or alternative data structures (with additional and/or alternative fields) may be used to store project data. Furthermore, while in the example above a relational database model has been used alternative database models could be used (e.g. a key-value pair data store or alternative database model).

In overview, the process of creating and managing projects in the PCT generally includes users (e.g. project owners) creating projects, users subscribing to projects, project owners providing updates on projects they own (or work on), and updating subscribers in respect of the projects they subscribe to, which are briefly described below.

As used herein, a “project update” refers to information related to (or contained in) an update provided by a project owner in respect of a project they own. For example, a user providing data to the PCT system in respect of a project they own and the system populating a project update record based on the user provided data. As used herein, a “subscriber update” refers to communicating one or more project updates in respect of project(s) to a subscriber who is subscribed to the project(s). For example, the PCT system communicating information related to (or contained in) a project update record, in respect of a project, to a user subscribed to the relevant project. In a subscriber update process, a collection of project updates may be communicated to a subscriber as a subscriber update. In this way, a subscriber update is a project update digest in respect of a given subscriber for a given update period. Whilst the description below is primarily in respect of projects and project updates, the PC application may also create and update goals, and display goal updates, as part of a subscriber update, in a corresponding manner to that of projects and project updates.

Subscribing to projects includes subscribing users to projects based on requests from users (e.g. using client application 242 on user device 240) to be subscribed to a project so that they receive project updates with respect to that project. As an example, the PCM module 222 may detect a user (e.g. using client application 242 on user device 240) activating a subscribe/follow control for the project that is presented by a user interface on a display (e.g. display 318 of user device 240). In response to detecting the activation of the subscribe/follow control, the PCM module 222 subscribes the user to the project by associating the user with the project in the data store 230. For example, the PCM module 222 may create a project subscription record (including the user ID and project ID) and write this to a project subscription table. The user may have to login to the client application 242 before they subscribe to projects and the PCM module 222 may be able to determine the user identifier of the user based on their login details. Alternatively, the user may provide their user identifier after activating the subscribe control. It is also envisioned that multiple users may be subscribed to one or more projects and that users may also unsubscribe or unfollow projects, for example, by activating a toggle follow/following control of a respective project.

Updating projects may include the project update module 224 periodically prompting project owners (e.g. through the client application 242) to provide a project update relating to their project, receiving such an update, and storing the project update in data store 230. For example, the project update module 224 may be configured to automatically and periodically request updates for all active projects maintained by system 210 according to a defined project update request cadence. For example, the project update request cadence may be defined so that project update processes are triggered for projects at: a particular time/day (the update time) of every week (the update period) (e.g. every Friday at 9 am); a particular time/day of every fortnight (e.g. every second Friday at 9 am); a particular time/day of every month (e.g. 9 am on the first Friday of every month), or at alternatively defined intervals. Project update request cadence may be configured as common, for all projects and project owners, or specific cadences may be defined for specific projects and/or project owners.

For each project update process, the project update module 224 determines the user identifier of the project owner of the project in question. As an example, the project update module 218 may determine the user identifier of the project owner by accessing a project details table stored in the data store 230. The project update module 218 generates a project update request. The project update request is a request to the project owner for a project update. The project update request (and data included therein) may take various forms. For example, the project update request may be provided in the form of an electronic communication (e.g. an email, an instant message, an SMS, or an alternative electronic communication) and include a link or control that, when activated by the project owner, causes the client application 242 to generate and display a project update user interface. The project owner may then input project update data in the project update user interface, which is subsequently communicated to and received by the project update module 224. Additionally or alternatively, in some embodiments, project updates may be provided by project owners before receiving project update requests.

Once the required update data has been received, the project communication module 224 creates a project update for the respective project based on the project update data received for that project and stores this project update against the project identifier for the project in the data store 230. For example, creating a project update may involve the project communication module 224 creating a project update record in a project updates table stored on the data store 230 and populating the project update fields as discussed above. The project update record defines the unique project identifier for the project to which the project update relates and one or more project update fields (e.g. the time the project update was created, the update description, and the project status).

Broadly speaking, subscriber update processes include generating a subscriber update for a subscriber (the subscriber update including project updates for projects the subscriber has subscribed to) and communicating the subscriber update to the subscriber. The subscriber update module 226 is configured to automatically and periodically generate updates for all users who subscribe to one or more projects according to a defined subscriber update cadence. For example, the subscriber update cadence may be defined so that subscriber update processes are triggered for subscribers at: a particular time/day (the update time) of every week (the update period) (e.g. every Friday at 9 am); a particular time/day of every fortnight (e.g. every second Friday at 9 am); a particular time/day of every month (e.g. 9 am on the first Friday of every month), or at alternatively defined intervals. Subscriber update cadence may be configured as common, for all projects and subscribers, or specific cadences may be defined for specific projects and/or subscribers. Generally, subscriber update cadence is configured as complimentary to project update cadence such that subscribers are provided updates of projects at the same or similar rate to which project owners update projects.

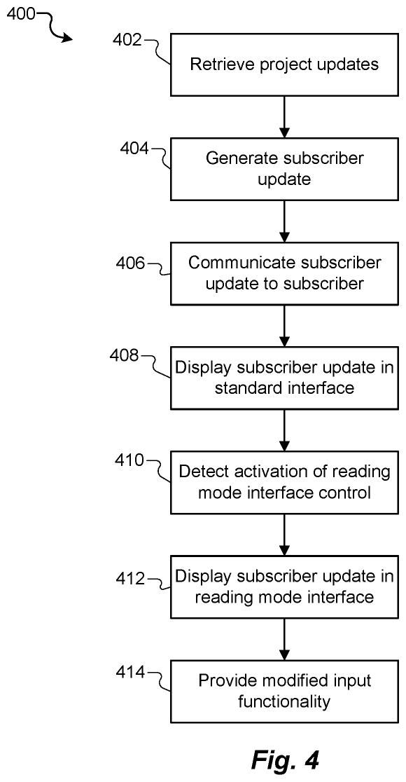

Turning to FIG. 4, a subscriber update method 400 for providing a subscriber with a subscriber update is described. The operations of method 400 are described as being performed by the PC server application 220 running on the PC server system 210 and the PC client application 242 running on the user device 240. In alternative embodiments, the processing may be performed by one or more alternative systems (operating in conjunction with PC server system 210 and user device 240 or independently) and/or alternative applications running on those systems. Additionally, the method 400 will be described with reference to providing a single subscriber a subscriber update, although the method may be scaled to provide multiple subscribers the same or different respective subscriber updates.

When a subscriber update process is triggered in accordance with the update cadence, for each subscriber, the subscriber update module 226 determines the projects the subscriber in question is subscribed to. This may be done, for example, by querying a subscriber table stored on the data store 230. In the above example, the subscriber table includes a record for each project that the subscriber in question is subscribed to. Each record includes the subscriber's user ID (allowing the subscriber to be identified) and a project ID (identifying the project subscribed to).

At step 402, the subscriber update module 226 retrieves the relevant project updates in respect of the subscriber. The subscriber update module 226 is configured to access the data store 230 and retrieve the project update data received in response to the latest project update request for each project the subscriber is subscribed to. In particular, the subscriber update module 226 may look up the identifier of the subscriber in a subscriber table record stored in data store 230 and retrieve all project IDs associated with the user's ID as a subscriber ID. The subscriber update module 226 then retrieves, from data store 230, data of the most recent project update record for each project the user is subscribed to. As an example, the subscriber update module 226 may access a project updates table stored on the data store 230 that defines a project update record for each project update created for each project. Each project update record defines the project identifier to which the project update records relates and project update data for the project (e.g. a timestamp relating to when the project update was created, update description, and a project status). The subscriber update module 226 may determine the project update received in response to the latest project update request for each project based on when the project update process was last triggered, the project identifier, and timestamp of each project update record. Where more than one project update record exists since the previous subscriber update (e.g. within the update period), the subscriber update module 226 may retrieve only the most recent project update or all project updates since the previous subscriber update. Where no project update record exists for a particular project since the previous subscriber update, the subscriber update module 226 may provide an indication that no update exists for the particular project.

At step 404, the subscriber update module 226 generates a subscriber update based on the retrieved project update(s) for each subscriber. In particular, the subscriber update module 226 gathers the retrieved project updates and collates the project updates to generate a subscriber update of the relevant update period for the subscriber. For example, the subscriber update module 226 may populate a subscriber update record with the respective project updates, for the relevant period, of the projects the user is subscribed to. If a project update was not received for a particular project in response to the latest project update request, the subscriber update module 226 may not retrieve any project data relating to that project. In this case, the subscriber update for a subscriber subscribed to this project may not include any project updates for this project or may include an indication that no project update was received for this project. The populated subscribed update record may be stored in data store 230. In some examples, the subscriber update module 226 may determine if there are any changes to the status or target date of a project (e.g., by comparing the latest project update for the project with the penultimate project update stored in the project updates table). If a change is identified in the status or target date based on this check, the subscriber update module 226 includes this change information in the subscriber update at this step.

Once the subscriber update has been generated, at step 406 the subscriber update module 226 communicates the subscriber update generated to the subscriber. As an example, the subscriber update module 226 may communicate the subscriber update to the subscriber as a subscriber update notification sent to the client application 242 on the subscriber's user device 240, by email to the subscriber's nominated email address(es), and/or by other communication means. As an example, the subscriber's user identifier stored in a subscriber table may be used to identify the subscriber's details in a user table to determine the subscriber's nominated email address(es). The subscriber update notification may include a subscriber update control that, when selected by the subscriber, causes the client application 242 to generate and display a subscriber update user interface (e.g. subscriber update user interface 500 or subscriber update user interface 600 described below). In some embodiments, a subscriber may log into the PC client application on their device and select a subscriber update control to view their latest subscriber update, thereby causing the subscriber update user interface to be displayed.

At step 408, a first subscriber update user interface 500 is displayed to the user. For ease of reference, the “first subscriber update user interface” is referred to as a “standard interface” herein. The standard interface may be (or correspond to) a default or homepage interface for displaying updates to users of the PC client application 242, for example, when the user first navigates to or opens the PC client application. The standard interface may be displayed in response to the subscriber activating the subscriber update control in the communication. Alternatively or additionally, the standard interface may be provided as a default home page for example, for displaying the (current) most recent subscriber update when a subscriber initially navigates to the PC client application 242 on their user device 240. The user interface module 228 is configured to cause the PC client application 242 to display the standard interface 500, for example, on display 318 of the user device 240.

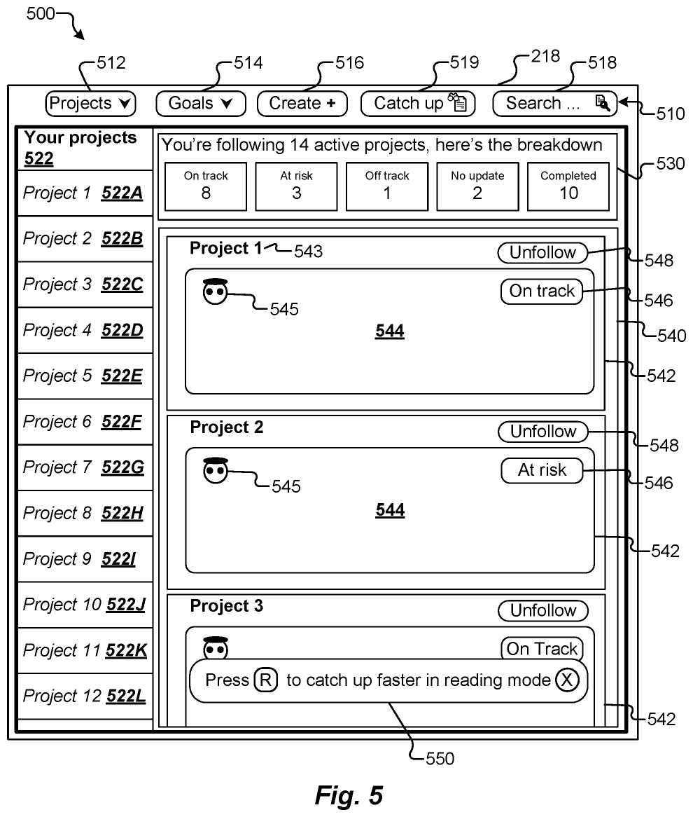

FIG. 5 illustrates an example standard interface 500. Similar to the UI 100, interface 500 includes a header section 510 containing control elements including a projects control element 512, a goal control element 514, a create control element 516, and a search control element 518. Selection of the various control elements results in the operation of corresponding actions. For example, selection of the projects control element 512 causes display of a projects section 522 (similar to the projects section of FIG. 1) Selection of the goals control element 514 causes display of a similar display of a goals section for displaying a list of goals subscribed to (i.e. followed) and/or owned by the user viewing the interface. Selection of the create control element 516 triggers operation of a method for a user to create a project or goal. Selection of search control element 518 triggers operation of a search process to search for users, projects, and/or goals within the PC application.

In addition, according to aspects of the present disclosure, the header section 510 may further include a reading mode interface control element 519. Selection of the reading mode interface control element 519 causes display of a reading mode user interface (e.g. interface 600 described further below) on the display 318.

As with UI 100, the interface 500 further includes a summary section 530 displaying a summary of the active projects the user viewing the interface has subscribed to follow, and a project updates section 540. The project updates section 540 displays project update objects 542 for each project the user has subscribed to. The project updates section 540 is a scrollable interface for allowing a subscriber to view each project update object 542 by scrolling through a list of project update objects 542. In one example, the project updates section 540 may be configured as an infinite scroll interface, allowing a user to scroll through (and down to) respective project update objects 542.

The project update objects 542 may include, e.g., a project name 543, a project update description 544, an avatar 545, a status indicator 546, and an unfollow control 548. The project update description 544 may include text or other content that has been entered with respect to the respective project update that was received by the system. Similarly, the status indicator 546 may reflect a status that was entered by the user or is being tracked by the system for the respective project update object 542. The unfollow control 548 may be a selectable affordance that, when selected, causes the respective subscriber to unsubscribe from the updates from the respective project, issue or user associated with the project update object 542.

In this example, respective project update objects 542 in respect of “Project 1” and “Project 2” are visible in the project updates section 540 of interface 500, with project update object 542 for “Project 3” only partially displayed on the display 318 of the subscriber's user device 240. The subscriber scrolls down through the project updates section 540 to view the project update object for “Project 3” fully. In order to view all project update objects 542 in respect of all projects the user is subscribed to, using interface 500, it is necessary to scroll down or otherwise search for specific projects. Interface 500 may further include the display of a notification or prompt 550, to provide an input to transition to a reading mode user interface 600. Prompt 550 may be displayed, for example, in response to a user scrolling within the project updates section.

Returning to method 400, at step 410, the user interface module 228 detects that a user wishes to launch a second subscriber update UI. The UI module may detect this, e.g., because a user activates the reading mode interface control 519 or activates any other shortcut key (e.g., the R key) that is associated with the reading mode user interface. The activation of the reading mode interface control or shortcut key may be detected based on a user input provided at their user device 240 and communicated back to the PC server system 210 (via network 202).

At 412, a second subscriber update user interface 600 is displayed to the user. For ease of reference, the “second subscriber update user interface” is referred to as a “reading mode user interface” herein. The reading mode user interface is specifically configured to display subscriber updates to subscribers and provide enhanced input functionalities while displaying updates.

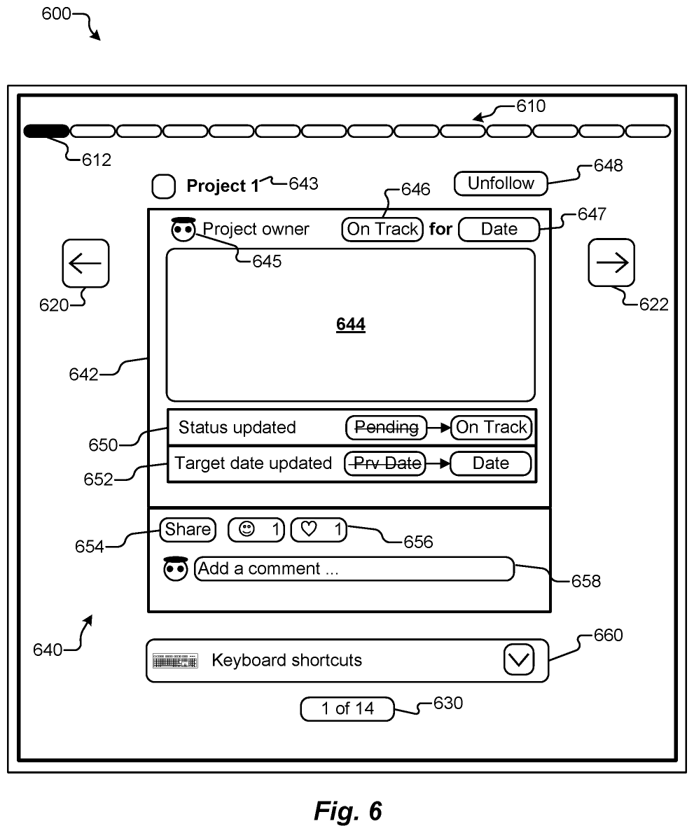

FIG. 6 illustrates an example reading mode user interface 600, i.e. a reading mode user interface 600, that is displayed at step 412. The interface 600 includes a project update queue 610. In general, the project updates will be queued for display in corresponding project update objects 642 in a predetermined order (e.g., most recent update first, earliest update first, in alphabetical order of project names, in alphabetical order of project owner, based on project status, etc.) When the order is based on a time property, the order can be determined based on the project update timestamp of the respective project update record).

In some examples, if no project update was received in respect of a project to which the subscriber is subscribed, a corresponding project update object may be provided at the end of the queue, wherein the relevant project update object when displayed provides an indication that no update was received for the project in the current update period.

The project update queue 610 includes an indication of the number of project updates in the subscriber update and an indication of each project update object to be displayed as part of the current subscriber update for a subscriber viewing the interface 600. In this example, queue 610 includes 14 interactive elements corresponding to updates in respect of 14 active projects, which the subscriber is currently following.

In some embodiments, each interactive element in the queue 610 is selectable to navigate to (and display) the project update record in respect of the relevant project. In this way, the queue 610 may function as a navigation bar control element such that a user may conveniently identify and navigate to a desired project update, skipping over intermediary project updates, and may also select project updates further along or behind the currently displayed project update in the queue.

In UI 600, the first indicator 612 corresponding to the first project is highlighted, indicating that the first project is currently selected in the queue. Thus, the project update object 642 containing information of the first project update is currently displayed.

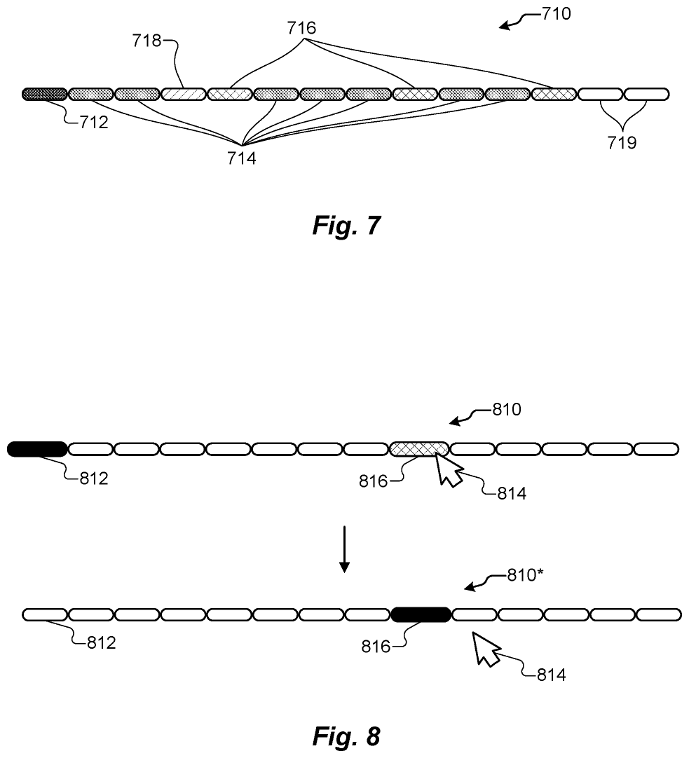

Referring to FIG. 7 there is depicted an alternative user interface element which may be incorporated with the reading mode user interface 600, for example by augmenting or substituting the project update queue 610. In the example of FIG. 7, a project update queue 710 provides an indication of the number of project update objects to be displayed as part of the current subscriber update for a subscriber viewing the interface, similar to the queue 610. Additionally, with project update queue 710, each of the elements respectively corresponding to project updates may further provide an indication of the status of the project to which they are directed. For example, each element may be color coded, shaded, or displayed with varying transparency to provide an indication of the status of the project (e.g., on track, at risk, off track, no update, etc.). In this example, the first interactive element 712 is displayed relatively solidly to indicate the first project update object is being displayed amongst the project updates in the project update queue 710. Amongst the 14 projects, for example, there may be statuses of 8 projects being on track (see 714), 3 at risk (see interactive elements 716), 1 off track (see interactive elements 718) and 2 having no update (see interactive elements 719). Accordingly, respective interactive elements may be color coded (or otherwise indicated) correspondingly. Advantageously, the interactive elements of project update queue 710 may provide an indication of the status of respective projects at a glance. Additionally, or alternatively, each interactive element may provide an indication of the proximity of respective target dates, for example, interactive elements in respect of projects with relatively close target dates in time may be displayed with emphasis (e.g., color coded, shaded, enlarged, bordered) relative to interactive elements in respect of projects with target dates further in the future.

Referring to FIG. 8 there is depicted an alternative user interface element which may be incorporated with the reading mode user interface 600, for example by augmenting or substituting the project update queue 610 and/or the project update queue 710. In the example of FIG. 8, a project update queue 810 provides an indication of the number of project update objects to be displayed as part of the current subscriber update for a subscriber viewing the interface, similar to the queue 610. In this example, the first interactive element 812 is also displayed solidly to indicate the first project update object is being displayed amongst the project updates in the queue 810. Additionally, interactive element 812 is expanded slightly in size to further indicate its selection. Furthermore, queue 810 is configured such that when an interactive element in respect of a project in the queue is navigated to, for example, using navigation keys or hovering a cursor 814 over the respective element, the display state of the interactive element changes—e.g., it may expand in size to indicate selection and/or provide an indication of the status of the corresponding project.

In this example, cursor 814 is hovering over interactive element 816 corresponding to the ninth project update in the queue 810, although the interactive element 816 has not yet been selected. In response, the ninth interactive element 816 has expanded in size (relative to the interactive elements two through eight and ten through fourteen) and also is actively showing a color coding/shading corresponding to the status of the project update to which it pertains. In particular, the interactive element 816 indicates that the ninth project update (corresponding to the ninth project) has a status of at risk. If the interactive element 816 is selected, the project update object 642 displayed in the project updates section 640 swaps from that of the first project update to that of the ninth project update. Accordingly, as seen in the post selection queue 820, once the interactive element 816 is selected (and the corresponding ninth project update is displayed), the first interactive element 812 reverts to the standard size and is no longer actively color coded or shaded. As the ninth project update object would then be displayed, the ninth interactive element 816 is depicted in bold and remains in an expanded size, even when the cursor 814 is no longer hovering over the ninth interactive element. Accordingly, queue 810 may enable navigation between display of project updates and may also allow a sweep of the queue to view the status of respective projects as the cursor hovers over the corresponding interactive element. Whilst this example is in respect of a cursor and particular expanding/shading, it is also envisioned that project queue interface elements could be suitably configured to respond to touch screen selections, gestures, and the like and/or alternative color coding/shading/expanding and/or indicating could be implemented.

Returning to FIG. 6, the reading mode user interface 600 further includes previous and next navigation control elements 620 and 622, which are respectively configured to navigate along the project updates in the project update queue 610.

The interface 600 also includes a project update number section 630 that indicates the number of the currently displayed project update amongst the project updates in the queue. In this example, the project update number section displays “1 of 14” corresponding to the currently displayed project update object 642 being for the first update amongst 14 project updates in the subscriber update.

In the reading mode user interface 600, the project updates section 640 occupies substantially all of the display space of the interface 600 with a current project update object 642 positioned centrally and desired control elements provided around the project update object 642.

The reading mode user interface 600 omits extraneous user interface elements, extraneous control elements and extraneous information to provide a more streamlined interface for digesting project updates. That is, the reading mode user interface 600 may strip away extraneous interface elements compared to the standard interface 500. Furthermore, reading mode user interface 600 may be displayed in the full screen (e.g., the UI 600 may fill the entire screen of the user device 240) such that every inch of the screen can be utilized and desktop distractions, such as notifications, other open browser tabs, etc. can be minimized).

The reading mode user interface 600 further includes control elements for users to engage with the project update to which the displayed project update object 642 is directed. User engagement control elements may include, e.g., a share control element 654, one or more reaction control elements 656, and a comment control element 658. The share control element 654 allows a user to share the respective project update object 642, for example, with another user of the PC application and/or with (or via) an external application. Reaction control elements 656 allow a user viewing the project update object 642 to leave a remark, in the form of a reaction, on the respective project update. Reactions may be predefined defaults (e.g. smiley face, heart, thumbs up) or selected from a list of options (e.g. in a pop-up interface). Reaction control elements 656 may also include a respective count of reactions made by users on the respective project update. Comment control element 658 allows a subscriber to post comments in relation to a project update object 642. If the subscriber selects the comment control 658, a comment interface may be displayed that allows the subscriber to enter and submit a comment. Comments previously left by users on the project update may also be displayed in the project update object 642. The remarks (e.g. reactions and comments) of project updates may be stored in a project update record relating to the project update in a project updates table stored on the data store 230.

While the reading mode user interface 600 is being displayed, the user interface module is configured to provide modified input functionality (for example by causing the client application 242 to respond to inputs particular to the reading mode user interface 600). In this example, the modified inputs are described as hotkeys, e.g., activations of keys of a keyboard 326 of the user device 240. In alternative embodiments, the modified inputs may be implemented by way of alternative input devices, for example, affordances and/or gestures on touch screen, dedicated input buttons of the device, or other suitable inputs. The reading mode user interface 600 may include a modified inputs guide section, in this example, a keyboard shortcuts guide section 660.

The keyboard shortcuts guide section 660 includes a control element to expand the guide and display hotkeys and corresponding functionalities performed in response to activation of such hotkeys. Particular examples of modified input (hotkey) functionality for the reading mode user interface 600 may include detecting keyboard 326 inputs provided by a user at their user device 240 such as: detecting activation of a left arrow key and in response, navigating to a previous project update; detecting activation of a right arrow key and in response, navigating to a next project update; detecting activation of an “x” key and in response, starting over from the first project update; detecting activation of an “m” key and in response, initiating a subscriber comment entry on a displayed project update; detecting activation of both a “window” key and an “enter” key during a subscriber comment entry and in response, submitting the comment for recording as a subscriber comment against the project update; detecting activation of a numerical key (e.g. “1”-“5”) and in response, adding a corresponding reaction to the project update; detecting activation of a “d’ key and in response, expanding content such as additional notes or media attached to or embedded within the displayed project update; and detecting activation of an “Esc” key and in response, exiting the reading mode user interface. Many alternative inputs and many alternative responses are possible without departing from the scope of the present disclosure.

The project update object 642 includes information about the corresponding project, e.g. information of the corresponding project update record. In this example, the project update object in respect of Project 1 is currently being displayed. In general, the project update object 642 displays information from the most recently submitted project update for the respective project in the given update period. In some embodiments, the project update object may be similar to the project update object 542 displayed in the UI 500. In other examples, the project update object 642 may include different, additional, or lesser information than the project update object 542. In one example, the project update object 642 may include a project name 643 section, a project update description section 644, an owner section 645, and an unfollow control 648 for allowing a user to unfollow (i.e. unsubscribe from) the respective project. In addition, the object 642 may include a status indicator section 646, and a target date indicator section 647.

The project name section 643 displays the project field data relating to the project name of the respective project (e.g. “Project 1”). The project update description section 644 displays the details of the project update description relating to the respective project to which the displayed project update object 642 is directed. The project update description section 644 may also include additional notes and/or linked or embedded media or other content. If a project owner has provided any additional notes or content relating to the project, the project update object 642 may include a notes control that, when selected by the subscriber, displays or expands the project owner's additional notes and/or content in relation to the project update (e.g. in a pop-up dialogue box or alternative user interface element). Alternatively, additional notes or content may be expanded in response to a user input such as activation of a hotkey. The owner section 645 may display an avatar or picture and/or name of the project owner, e.g., the person or team that created the update for the respective project.

The status indicator section 646 displays project data relating to the project status (e.g. on track, at risk, off track) of the project to which the project update object is directed. The target date indicator section 647 provides an indication of when the project is due (or currently expected) to be completed. The target date indicator 647 may indicate a specific date, or a period of time (e.g. a specific month or a specific quarter). In case there is no target date (e.g., because the project has been deferred), the target date indicator 647 may display such status, e.g., “deferred”. In particular, the status indicator 646 and target date indicator 647 display the most recent project status and target date submitted by the project owner in respect of the project.

Additionally, the project update object 642 includes a status update section 650 and a target date update section 652. The status update section 650 provides an indication of an update to (or change in) the status of the project to which the project update object 642 is directed. In particular, the status update section 650 displays a previous status of the respective project along with the now current status of the project. The previous status may be struck out, greyed out, partially transparent or otherwise include an indication to indicate that it has been superseded by the current status. Additionally or alternatively, the current status may be highlighted and/or accented. Similarly, the target date section 652 provides an indication of an update to (or change in) the target date of the project to which the project update object 642 is directed.

In particular, the target date update section 652 displays a previous target date of the respective project along with the new target date of the project. The previous target date may be struck out, greyed out, partially transparent or otherwise include an indication to indicate that it has been superseded by the current status. Additionally or alternatively, the current target date may be highlighted and/or accented.

It will be appreciated that the status update and/or the target date update section may be displayed in case where the subscriber update module 226 determines there is a change in the project field data of, respectively, either the status and/or target date of a project between the most recent project update for the update period and the project update of the previous period. This determination may be made during the generation of the subscriber update, for example, at step 404 of method 400.

Advantageously, the reading mode user interface 600 disclosed herein may enable a subscriber to view and digest all project updates in their current subscriber update, navigate between project update objects and leave remarks such as comments and/or reactions as well as expand and view additional notes or embedded content in respect of projects, in an efficient and easy to use interface. The reading mode user interface 600 is further configurable to allow full functionality responsive to modified inputs such that a user may view and engage with all project updates utilizing only the specially configured hotkeys, and thus, not necessarily requiring a cursor control device or the like. This may further improve the human-machine interface provided by the client application.

Returning to method 400, at step 414, the user interface module 228 is configured to provide modified input functionality, wherein inputs provided at the user device 240 affect alternative functions within the reading mode user interface 600 as compared to when the reading mode user interface is not being displayed in the PC client application 242. For example, inputs (such as hotkeys in respect of a keyboard 326 or gestures or selections in respect of a cursor control device 324) input to the reading mode user interface 600 result in alternative functionalities as compared to the same inputs being input to another interface, such as the standard interface 500. Modified input functionality is described further below with respect to method 900.

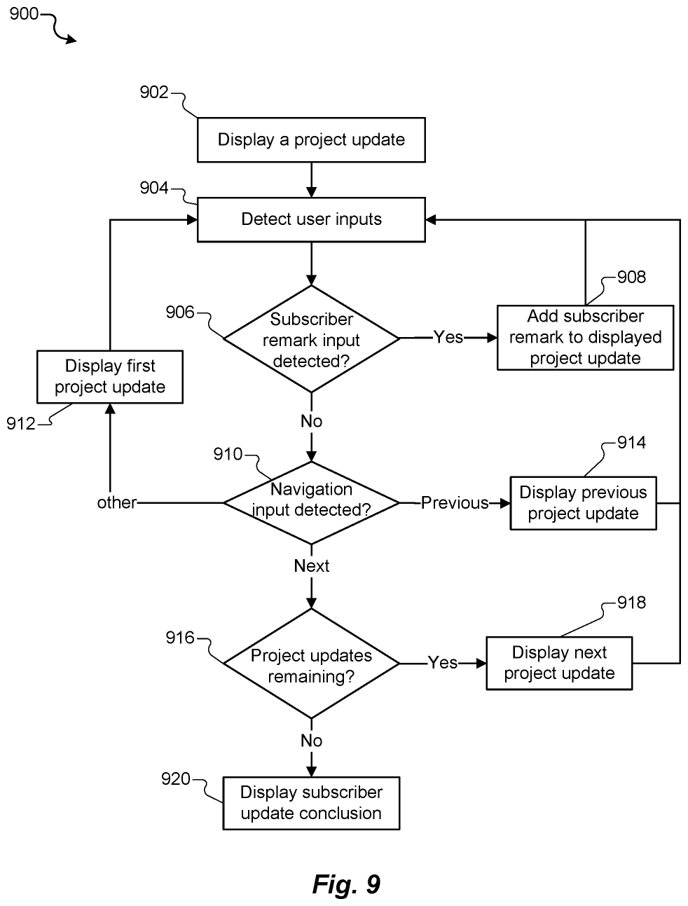

Referring to FIG. 9, the operations of displaying subscriber updates in a reading mode user interface and providing modified input functionality will now be described. The operations of method 900 will be described as being performed by the (modules of) PC server application 220 running on the PC server system 210 and the PC client application 242 running on the user device 240. In alternative embodiments, the processing may be performed by one or more alternative systems (operating in conjunction with PC server system 210 and user device 240 or independently) and/or alternative applications running on those systems. Additionally, the method 900 will be described with reference to providing a single subscriber a subscriber update, although the method may be scaled to provide multiple subscribers the same or different respective subscriber updates.

Method 900 commences after step 410 of method 400—i.e., after reading mode user interface 600 is displayed.

At step 902, the user interface module 228 causes the PC client application 242 to display a project update object 642 within the project updates section 640. Initially, the project update object displayed will be the first object in the queue (e.g., in queue 610, 710 or 810).

At step 904, while displaying a project update object, the user interface module 228 is configured to detect user inputs, for example, detected via an input/output device of the user device 240 such as a touch screen of display 318 or a keyboard 326. Inputs activated at the user device 240 may then be provided to the user interface module 228 which is configured to cause the PC client application 242 to respond to the inputs with a modified functionality, particular to the reading mode user interface 600. Each user input may be relayed back to the user interface module 228 of the PC server application 220, or alternatively, the user interface module 228 may configure the client application 242 to locally respond to the detected user inputs based on the configured operations for the reading mode user interface 600.

At step 906, the client application 242 (and/or user interface module 228) determines whether a subscriber remark input has been detected. A subscriber remark may be, e.g., a comment, a share, and/or selection of an emoticon. The user interface module 228 may configure the client application 242 to recognize particular user inputs as subscriber remark inputs while the reading mode user interface 600 is being displayed. For example, an “m” key may be programmed to correspond to a control for entering a comment, an “s” key may be programmed to correspond to a control for sharing the displayed project update, and numerical keys 1-5 may be programmed to correspond to particular emoticons. In this case, when activation of the “m” key, “s” key, and/or one of the numerical keys 1-5 is detected while the user is in UI 600, the client application 242 or the server application 220 determines that the user wishes to enter a remark with respect to the displayed project update or share the displayed project update and the method proceeds to step 908, where the user interface 600 allows the subscriber to perform the corresponding action. For example, if the “m” key is detected, the comment editor bar 658 may be activated and a cursor may be activated in the comment editor bar 658. The user can then directly type their comment (e.g., using their keyboard). Once the user is satisfied with the comment, the user can select another key, e.g., the “enter” key, which causes the comment entered in the editor bar to be submitted. Similarly, if the “s” key is detected, a share UI (not shown) may pop-up, allowing a user to select the name of the person and/or the external application or website with which the user wishes to share the project update. If one of the numerical keys is detected, a corresponding emoticon may be selected and an update may be submitted. For example if the numerical key “1” is associated with the smiley emoticon, selection of the numerical key “1” may result in the client application 242 generating and communicating a request to update the project record to indicate that the user has selected the smiley emoticon and to also increment the counter associated with the smiley emoticon for that project record. If the counter is displayed in UI 600, this may also be incremented at this step.

A second selection of the same numerical key may result in the corresponding emoticon being deselected. For example if the numerical key “1” is selected a second time, the client application 242 generates and communicates a request to update the project record to indicate that the user has unselected the smiley emoticon and to also decrement the counter associated with the smiley emoticon for that project record. If the counter is displayed in UI 600, this may also be decremented at this step and the corresponding emoticon may be de-highlighted.

Accordingly, at step 908, activation of a subscriber remark input allows the subscriber to record a remark, for example, by storing the remark in the remarks field of a project update record, stored in the data store 230, in respect of the relevant project. If no (further) subscriber remark input(s) are detected, the client application 242 is configured (e.g. by the user interface module 228) to continue monitoring for user inputs.

At step 910, the client application 242 (and/or user interface module 228) determines whether a navigation input has been detected. For example, navigation inputs may include inputs to navigate to a next project update, a previous project update, or start over at the first project update. As an example, a left arrow key may be configured as a hotkey for displaying a previous project update; a right arrow key may be configured as a hotkey for displaying a next project update; and an “x” key may be configured as a hotkey for restarting and displaying the first project update. If activation of these hotkeys, activation of the controls 620, 622, or selection of a particular activation element in queue 610, 710 or 810 is detected, the client application 242 is configured to navigate to the respective project update, e.g., by displaying the corresponding project update object.

In particular, if activation of a start over input is detected or if activation of a particular element in queue 610, 710 or 810 is detected at 910, the method proceeds to step 912 where the client application 242 is configured to replace the currently displayed project update object with the project update object corresponding to the selected project update, which is the first project update in queue 610, 710 or 810 in case a start over input is detected or another project update object in case a random project update activation element is selected from queue 610, 710 or 810.

If activation of the previous project update input is detected (e.g., left arrow or control 620) at step 910, the method proceeds to step 914, where the client application 242 is configured to replace the currently displayed project update object with the previous project update object in the queue. If the currently displayed project update object is the first project update object (i.e. there is no previous object update) the client application 242 may be configured to continue displaying the first project update object and not perform any action.

If activation of the next project update input is detected (e.g., right arrow or control 622) at step 910, the method proceeds to step 916 where the client application 242 (and/or user interface 600) is configured to determine whether there are any further project updates remaining amongst the projects to which the user is subscribed to. This determination may be made in advance by the PC server application 120 and provided to the client application 242 as part of the subscriber update record such that the client application 242 can locally determine whether any unviewed project updates remain in the queue. For example, the client application 242 (and/or user interface module) may refer to the number of project updates stored in a subscriber update table.

If it is determined that further unviewed project update objects remain in the queue, the method proceeds to step 918 where the client application 242 is configured to replace the currently displayed project update object with the project update object corresponding to the next project update amongst the projects in the subscriber update.

Alternatively, if it is determined that no further project updates remain for the subscriber update, the method proceeds to step 920, where the client application 242 is configured to display a subscriber update conclusion. The subscriber update conclusion may replace the displayed final project update object and may include a summary of project updates in the subscriber update and/or a congratulation to the subscriber for viewing all project updates. The client application 242 may be further configured to detect activation of a user input while displaying the subscriber update conclusion, for example, detection of start over input (e.g. activation of an “x” key hotkey) may cause the client application to start over by re-displaying the first project update object.

If at any time during process 900, activation of an exit input is detected (e.g., to exit the reading mode UI 600), the method 900 ends and the UI 600 is exited. In such cases, the user display may revert to the standard UI 500 upon exiting the reading mode.

In the above embodiments, certain operations are described as being performed by the user device 240 (e.g. under control of the client application 242) and other operations are described as being performed at the server system 210. Variations are, however, possible. For example in certain cases an operation described as being performed by user device 240 may be performed at the server system 210 and, similarly, an operation described as being performed at the server system 210 may be performed by the user device 240. Generally speaking, however, where user input is required such user input is initially received at user device 240 (by an input device thereof). Data representing that user input may be processed by one or more applications running on user device 240 or may be communicated to server system 210 for server application 220 running on the server system 210 to process. Similarly, data or information that is to be output to a user (e.g. via display, speaker, or other mechanism) will ultimately be generated by user device 240. The data/information that is output by the user device 240 may, however, be generated by client application 242 and/or the server application 220 (and communicated to the user device 240 to be output).

Furthermore, in certain implementations a computer processing system 300 may be configured (by an application running thereon) to perform the processing described herein entirely independently of a server system 210. In this case, the application running on that system is a stand-alone application and all instructions and data required to perform the operations described above are stored on user device 240.

In the embodiments described above and the figures, various examples of how different types of GUI elements (and/or different GUI areas/regions) may be visually distinguished are provided. Alternative means for visually distinguishing GUI elements are possible. By way of example, techniques for visually distinguishing GUI elements may include one or a combination of: shading colours; shading patterns; line colours; line weights; line styles; transparencies; icons; character annotations; and/or other visual techniques.

The flowcharts illustrated in the figures and described above define operations in particular orders to explain various features. In some cases the operations described and illustrated may be able to be performed in a different order to that shown/described, one or more operations may be combined into a single operation, a single operation may be divided into multiple separate operations, and/or the function(s) achieved by one or more of the described/illustrated operations may be achieved by one or more alternative operations. Still further, the functionality/processing of a given flowchart operation could potentially be performed by different systems or applications.

Unless otherwise stated, the terms “include” and “comprise” (and variations thereof such as “including”, “includes”, “comprising”, “comprises”, “comprised” and the like) are used inclusively and do not exclude further features, components, integers, steps, or elements.

Although the present disclosure uses terms “first,” “second,” etc. to describe various elements, these terms are used only to distinguish elements from one another and not in an ordinal sense. For example, a first user interface could be termed a second user interface or vice versa without departing from the scope of the described examples. Furthermore, when used to differentiate elements or features, a second user interface could exist without a first user interface. For example, a second user input could occur before a first user input (or without a first user input ever occurring).

It will be understood that the embodiments disclosed and defined in this specification extend to alternative combinations of two or more of the individual features mentioned in or evident from the text or drawings. All of these different combinations constitute alternative embodiments of the present disclosure.

The present specification describes various embodiments with reference to numerous specific details that may vary from implementation to implementation. No limitation, element, property, feature, advantage or attribute should be considered as a required or essential feature. Accordingly, the specification and drawings are to be regarded in an illustrative rather than a restrictive sense.

1. A computer implemented method comprising:
maintaining a plurality of subscriber updates in a data store, each subscriber update including a plurality of respective object updates in respect of objects subscribed to by subscribers, each object update including a latest object information associated with the object;
displaying a standard user interface, the standard user interface including display of the plurality of respective object updates in respect of the objects subscribed by a first subscriber, the object updates arranged in a sequential list and the standard user interface including a scrolling mechanism to scroll through the sequential list;
detecting activation of a reading mode control displayed on the standard user interface;
in response to detecting activation of the reading mode control, replacing the standard user interface with a reading mode user interface, the reading mode user interface including display of a first object update of the plurality of respective object updates at a time; and
while displaying the reading mode user interface, detecting a navigation input and in response to the navigation input, ceasing display of the first object update and displaying a second object update of the plurality of respective object updates in the reading mode user interface.

2. The computer implemented method of claim 1, further comprising providing modified input functionality when displaying the reading mode user interface, wherein the same input results in an alternative operation being performed in the reading mode user interface as compared to the standard user interface.

3. The computer implemented method of claim 1, wherein the reading mode user interface includes an object update queue, the object update queue indicating a number of object updates in the subscriber update.

4. The computer implemented method of claim 3, wherein the object update queue includes a plurality of interactive elements, each interactive element corresponding to an object update in the subscriber update.

5. The computer implemented method of claim 4, further comprising:
detecting an input in the object update queue, the input selecting an interactive element of the plurality of interactive elements that corresponds to a third object update,
changing a display state of the selected interactive element, to indicate that the interactive element has been selected; and
ceasing display of the second object update and displaying the third object update in the reading mode user interface.

6. The computer implemented method of claim 1, wherein while displaying the second object update in the reading mode user interface, further comprises:
detecting a user input;
determining whether the user input is a subscriber remark input; and
upon determining that the user input is the subscriber remark input, receiving the subscriber remark input and recording the subscriber remark input in a remarks field of an object update record for the second object update.

7. The computer implemented method of claim 1, wherein while displaying the reading model interface, further comprises:
detecting activation of an exit input;
ceasing to display the reading mode user interface; and
displaying the standard user interface.

8. A computer processing system comprising:
a processing unit;
a display;
an input device; and
a non-transitory computer-readable storage medium storing instructions, which when executed by the processing unit, cause the processing unit to:
maintain a plurality of subscriber updates in a data store, each subscriber update including a plurality of respective object updates in respect of objects subscribed to by subscribers, each object update including a latest object information associated with the object;
display, on the display, a standard user interface, the standard user interface including display of the plurality of respective object updates in respect of the objects subscribed by a first subscriber, the object updates arranged in a sequential list and the standard user interface including a scrolling mechanism to scroll through the sequential list;
detect activation, via the input device, of a reading mode control displayed on the standard user interface;
in response to detecting activation of the reading mode control, replace the standard user interface with a reading mode user interface, the reading mode user interface including display of a first object update of the plurality of respective object updates at a time; and
while displaying the reading mode user interface, detect a navigation input and in response to the navigation input, ceasing display of the first object update and displaying a second object update of the plurality of respective object updates in the reading mode user interface.

9. The computer processing system of claim 8, wherein the non-transitory computer-readable storage medium further stores instructions, which when executed by the processing unit, cause the processing unit to provide modified input functionality when displaying the reading mode user interface, wherein a same user input results in an alternative operation being performed in the reading mode user interface as compared to the standard user interface.

10. The computer processing system of claim 8, wherein the reading mode user interface includes an object update queue, the object update queue indicating a number of object updates in the subscriber update.

11. The computer processing system of claim 10, wherein the object update queue including a plurality of interactive elements, each interactive element corresponding to an object update in the subscriber update.

12. The computer processing system of claim 11, wherein each interactive element providing an indication of a status of the object update.

13. The computer processing system of claim 11, wherein when a user navigates to an interactive element in the object update queue without selecting the interactive element, a state of the interactive element changes to provide an indication of a status of the object update corresponding to the interactive element.

14. The computer processing system of claim 11, wherein the non-transitory computer-readable storage medium further stores instructions, which when executed by the processing unit, cause the processing unit to:
detect an input in the object update queue, the input selecting an interactive element of the plurality of interactive elements that corresponds to a third object update,
change a display format of the selected interactive element, to indicate that the interactive element has been selected; and
cease display of the second object update and displaying the third object update in the reading mode user interface.

15. The computer processing system of claim 8, wherein, while displaying the second object update in the reading mode user interface, the non-transitory computer-readable storage medium further stores instructions, which when executed by the processing unit, cause the processing unit to:
detect a user input in the reading mode user interface;
determine whether the user input is a subscriber remark input; and
upon determining that the user input is the subscriber remark input, receive the subscriber remark input and recording the subscriber remark input in a remarks field of an object update record for the second object update.

16. The computer processing system of claim 8, wherein, while displaying the second object update in the reading mode user interface, the non-transitory computer-readable storage medium further stores instructions, which when executed by the processing unit, cause the processing unit to:
detect activation of an exit input in the reading mode user interface;
cease to display the reading mode user interface; and
display the standard mode interface.

17. A non-transitory storage medium storing instructions executable by processing unit to cause the processing unit to:
maintain a plurality of subscriber updates in a data store, each subscriber update including a plurality of respective object updates in respect of objects subscribed to by subscribers, each object update including a latest object information associated with the object;
display, on the display, a standard user interface, the standard user interface including display of the plurality of respective object updates in respect of the objects subscribed by a first subscriber, the object updates arranged in a sequential list and the standard user interface including a scrolling mechanism to scroll through the sequential list;
detect activation, via an input device, of a reading mode control displayed on the standard user interface;
in response to detecting activation of the reading mode control, replace the standard user interface with a reading mode user interface, the reading mode user interface including display of a first object update of the plurality of respective object updates at a time; and
while displaying the reading mode user interface, detect a navigation input and in response to the navigation input, ceasing display of the first object update and displaying a second object update of the plurality of respective object updates in the reading mode user interface.

18. The non-transitory storage medium of claim 17, further storing instructions, which when executed by the processing unit, cause the processing unit to provide modified input functionality when displaying the reading mode user interface, wherein a same user input results in an alternative operation being performed in the reading mode user interface as compared to the standard user interface.

19. The non-transitory storage medium of claim 17, wherein the reading mode user interface includes an object update queue, the object update queue indicating a number of object updates in the subscriber update, wherein the object update queue including a plurality of interactive elements, each interactive element corresponding to an object update in the subscriber update.

20. The non-transitory storage medium of claim 19, wherein each interactive element in the object update queue provides an indication of a status of the object update.
